(19) United States
(12) Patent Application Publication
(10) Pub. No.: US 2026/0233432 A1
(43) Pub. Date: Aug. 13, 2026

(54) MAGNETO-DIELECTRIC COMPOSITE POWDER

(71) Applicant: ROGERS CORPORATION, Chandler, AZ (US)

(72) Inventor: Nazeef Azam, Manchester, CT (US)

(21) Appl. No.: 19/529,605

(22) Filed: Feb. 4, 2026

Related U.S. Application Data
(60) Provisional application No. 63/755,336, filed on Feb. 7, 2025.

(51) Int. Cl. B29B 9/06; B29C 70/88; C08J 5/18; C08K 3/013

(52) U.S. Cl. CPC B29B 9/06; B29C 70/88; C08J 5/18; C08K 3/013; B29K 2995/0006; B29K 2995/0008; C08K 2201/01

(57) ABSTRACT

A method of forming a magneto-dielectric composite powder including forming a solution comprising a polymer, a magnetic filler, and a solvent; forming a film from the solution; and forming the magneto-dielectric composite powder from the film.

### CROSS REFERENCE TO RELATED APPLICATION

The present application claims the benefit of priority to United States Application No. 63/755,336, filed February 7, 2025, the content of which is incorporated by reference in its entirety herein.

### BACKGROUND

Disclosed is a magneto-dielectric composite powder.

Magneto-dielectric composite materials have a relative permittivity and permeability of greater than 1. Magneto-dielectric composite materials can be synthesized from a low loss, high resistivity ceramic filler and thermoplastic matrix.

To match the coefficient of thermal expansion of copper for thermal reliability high temperature polytetrafluoroethylene (PTFE) resin can be included in the magneto-dielectric composite material. Method of manufacturing PTFE-based magneto-dielectric laminates can include compounding constituents via extruder followed by calendering the extruded material in sheet forms. The compounded sheets can then be trimmed and stacked to be laminated to a desired thickness. The process of trimming can create waste, decreasing overall yield. The final dimension of the laminated material can be limited based on the calendered thickness.

There is a need for methods and magneto-dielectric composite materials with improved yield and processing flexibility.

### BRIEF SUMMARY

In an aspect, a method of forming a magneto-dielectric composite powder includes forming a solution comprising a polymer, a magnetic filler, and a solvent; forming a film from the solution; and forming the magneto-dielectric composite powder from the film.

The above-described and other features are exemplified by the following detailed description and claims.

### DETAILED DESCRIPTION

Disclosed are methods of forming a magneto-dielectric composite powder, for example, non-PTFE based magneto-dielectric composite powder, and methods for manufacturing magneto-dielectric composites therefrom. The magneto-dielectric composite powder can provide for a reduction in waste in a method of forming a magneto-dielectric composite article and increase yield in a method of forming a magneto-dielectric composite article. The magneto-dielectric composite powder can also enable an expansion of the range of dimensions of manufactured magneto-dielectric composite articles.

The magneto-dielectric composite powder includes a polymer and a magnetic filler. As used herein, the phrase “magnetic filler” means a material that both has dielectric properties and magnetic properties. Exemplary magnetic fillers are described in U.S. Patent Application Publication No. 2021/0020343 A1, the content of which is incorporated herein by reference in its entirety. The magnetic filler can have a size of less than 20 micrometers.

As used herein, the phrase “composite powder” is not limited to any certain geometry, such as spherical. As disclosed herein, the composite powder can be formed by shredding a film or extrude including polymer and magnetic filler. The composite powder can have a size in a range of 1 to 300 micrometers.

The polymer can include a thermoplastic or a thermoset. As used herein, the term “thermoplastic” refers to a material that is plastic or deformable, melts to a liquid when heated, and freezes to a brittle, glassy state when cooled sufficiently. Examples of thermoplastic polymers that can be used include cyclic olefin polymers (including polynorbornenes and copolymers containing norbornenyl units, for example, copolymers of a cyclic polymer such as norbornene and an acyclic olefin such as ethylene or propylene), fluoropolymers (for example, polyvinyl fluoride, polyvinylidene fluoride, fluorinated ethylene-propylene (FEP), polytetrafluoroethylene (PTFE), poly(ethylene-tetrafluoroethylene, or perfluoroalkoxy (PFA)), polyacetals (for example, polyoxyethylene or polyoxymethylene), poly(C₁₋₆ alkyl)acrylates, polyacrylamides (including unsubstituted and mono-N- or di-N—(C₁₋₈ alkyl)acrylamides), polyacrylonitriles, polyamides (for example, aliphatic polyamides, polyphthalamides, or polyaramides), polyamideimides, polyanhydrides, polyarylene ethers (for example, polyphenylene ethers), polyarylene ether ketones (for example, polyether ether ketones or polyether ketone ketones), polyarylene ketones, polyarylene sulfides (for example, polyphenylene sulfides), polyarylene sulfones (for example, polyethersulfones (PES) or polyphenylene sulfones), polybenzothiazoles, polybenzoxazoles, polybenzimidazoles, polycarbonates (including homopolycarbonates or polycarbonate copolymers such as polycarbonate-siloxanes, polycarbonate-esters, or polycarbonate-ester-siloxanes), polyesters (for example, polyethylene terephthalates, polybutylene terephthalates, polyarylates, or polyester copolymers such as polyester-ethers), polyetherimides (for example, copolymers such as polyetherimide-siloxane copolymers), polyimides (for example, copolymers such as polyimide-siloxane copolymers), poly(C₁₋₆ alkyl)methacrylates, polyalkylacrylamides (for example, unsubstituted and mono-N- or di-N—(C₁₋₈ alkyl)acrylamides), polyolefins (for example, polyethylenes, such as high density polyethylene, low density polyethylene, or linear low density polyethylene, polypropylenes, or their halogenated derivatives (such as PTFE), or their copolymers, for example, ethylene-alpha-olefin copolymers), polyoxadiazoles, polyoxymethylenes, polyphthalides, polysilazanes, polysiloxanes (silicones), polystyrenes (for example, copolymers such as acrylonitrile-butadiene-styrene or methyl methacrylate-butadiene-styrene), polysulfides, polysulfonamides, polysulfonates, polysulfones, polythioesters, polytriazines, polyureas, polyurethanes, vinyl polymers (for example, polyvinyl alcohols, polyvinyl esters, polyvinyl ethers, polyvinyl halides (for example, polyvinyl chloride), polyvinyl ketones, polyvinyl nitriles, or polyvinyl thioethers), a paraffin wax, or a combination thereof. The thermoplastic polymer can be chosen based on characteristics thereof such as temperature stability and low dielectric loss.

Thermoset polymers are derived from thermosetting monomers or prepolymers (resins) that can irreversibly harden and become insoluble with polymerization or cure, which can be induced by heat or exposure to radiation (e.g., ultraviolet light, visible light, infrared light, or electron beam (e-beam) radiation). Thermoset polymers include, for example, alkyds, bismaleimide polymers, bismaleimide triazine polymers, cyanate ester polymers, benzocyclobutene polymers, benzoxazine polymers, diallyl phthalate polymers, epoxies, hydroxymethylfuran polymers, melamine-formaldehyde polymers, phenolics (including phenol-formaldehyde polymers such as novolacs and resoles), benzoxazines, polydienes such as polybutadienes (including homopolymers or copolymers thereof, e.g., poly(butadiene-isoprene)), polyisocyanates, polyureas, polyurethanes, triallyl cyanurate polymers, triallyl isocyanurate polymers, certain silicones, or polymerizable prepolymers (e.g., prepolymers having ethylenic unsaturation, such as unsaturated polyesters, polyimides). The prepolymers can be polymerized, copolymerized, or crosslinked, e.g., with a reactive monomer such as styrene, alpha-methylstyrene, vinyltoluene, chlorostyrene, acrylic acid, (meth)acrylic acid, a (C₁₋₆ alkyl)acrylate, a (C₁₋₆ alkyl)methacrylate, acrylonitrile, vinyl acetate, allyl acetate, triallyl cyanurate, triallyl isocyanurate, or acrylamide.

A first method of forming a magneto-dielectric composite powder includes forming a solution including a polymer, a magnetic filler, and a solvent; forming a film from the solution; and forming the magneto-dielectric composite powder from the film. A ratio of the polymer to magnetic filler can be selected based on desired properties of the magneto-dielectric composite powder, magneto-dielectric composite article, or a combination thereof. A solids content of the solution can be adjusted for desired processability. The polymer can comprise a thermoset, and the solution can further include an initiator. The initiator can include a free radical initiator such as a peroxide. Exemplary initiators include di-tert-butyl peroxide, dicumyl peroxide, tert-butylperoxyisopropyl, t-butyl cumyl peroxide, 2,5-dimethyl-2,5-di-(tert-butylperoxy) hexane, 1,1-di(t-butylperoxy)-3,3,5-trimethylcyclohexane, tert-butylperoxy 2-ethylhexyl carbonate, and a di-tertiary-butyl peroxide.

The solvent is selected so as to dissolve the polymer, disperse the magnetic filler, and to have a convenient evaporation rate for forming and drying. A non-exclusive list of possible solvents is xylene; toluene; methyl ethyl ketone; methyl isobutyl ketone; hexane, and higher liquid linear alkanes, such as heptane, octane, nonane, and the like; cyclohexane; isophorone; various terpene-based solvents; and blended solvents.

The solution can be coated on a carrier such as a copper foil, a polyethylene terephthalate (PET) carrier, a modified PET carrier, or a biaxially oriented polypropylene carrier, for example, via knife over roll or a slot die coating technique. Coating techniques such as slot die coating and knife over roll can include continuously agitation the solution, for example, using a inline mixer or an in vessel mixer. In a slot die coating process, the thickness of the coated film can be controlled by pump speed and speed of the line. In a knife over roll process, the film thickness can be controlled by the gap knife and roll between the knife and roll and solids of the solution. Solids of the solution can be adjusted between 20 to 80 weight percent to adjust the fluid viscosity for optimal processing.

The coated carrier than then be dried, for example, by passing the coated carrier through a drying oven, evaporating at least a portion of the solvent and forming a film. Dryer temperature and conditions can be adjusted depending on the solvent in use.

Magneto-dielectric composite powder can be formed from the film by shredding and milling the film. A cast film can be removed, e.g., released, from or off the carrier and shredded using a grinding mill. Screens can be used to achieve a desired milling size. Temperature can be monitored to ensure the temperature does not exceed the melting temperature of the polymer or the initiation temperature of the initiator. Liquid nitrogen can be used as an inert cooling medium when feeding the film to a grinder or grinding mill.

When formed from a film, which is formed from the solution including polymer, magnetic filler, and solvent, the magneto-dielectric composite powder can be in the form of magnetic filler encapsulated by polymer. Such magneto-dielectric composite powder can have a density of, for example, 1 to 5.5 grams per cubic centimeter or 5 to 5.5 grams per cubic centimeter, which value would be between the density of the polymer and the density of the magnetic filler.

A second method of forming a magneto-dielectric composite powder includes compounding a polymer and a magnetic filler to form a compounded mixture; extruding the compounded mixture to form an extrudate; and forming the magneto-dielectric composite powder from the extrudate. A ratio of the polymer to magnetic filler can be selected based on desired properties of the magneto-dielectric composite powder, magneto-dielectric composite article, or a combination thereof. The extrusion can include, for example, use of a twin screw extruder or a hot melt extruder. When formed from an extrudate, the magneto-dielectric composite powder can be in the form of magnetic filler encapsulated by polymer.

Magneto-dielectric composite powder can be formed from the extrudate by shredding and milling the extrudate, for example, using a grinding mill. Screens can be used to achieve a desired milling size. Temperature can be monitored to ensure the temperature does not exceed the melting temperature of the polymer or the initiation temperature of the initiator. In the case of using a thermoset in the second method, a high temperature initiator, e.g., an initiator with an initiation temperature that is at least 50 °C higher than a melt temperature of the thermoset, can be used to avoid curing the polymer during extrusion. Liquid nitrogen can be used as an inert cooling medium when feeding the extrudate to a grinder or grinding mill. The magneto-dielectric composite powder can have a density of, for example, 1 to 5.5 grams per cubic centimeter or 5 to 5.5 grams per cubic centimeter, which value would be between the density of the polymer and the density of the magnetic filler.

A magneto-dielectric composite article can be formed by molding the magneto-dielectric composite powder. The molding can include, for example, compression molding, injection molding, or reaction injection molding. When the polymer includes a thermoplastic, molding the magneto-dielectric composite powder to form the magneto-dielectric composite article can include subjecting the magneto-dielectric composite powder to a temperature of 80 to 250 °C and a pressure of 50 to 1,000 pound per square inch (345 to 6,895 kilopascals). When the polymer includes a thermoset, the molding can be performed at a temperature of less than 30 °C.

When the polymer includes a thermoset, molding the magneto-dielectric composite powder to form the magneto-dielectric composite article can include loading the magneto-dielectric composite powder into a mold and the method of forming the magneto-dielectric composite article can further include removing the magneto-dielectric composite article from the mold and curing the magneto-dielectric composite article outside of the mold.

Set forth below are non-limiting aspects of this disclosure.

Aspect 1: A method of forming a magneto-dielectric composite powder, the method comprising: forming a solution comprising a polymer, a magnetic filler, and a solvent; forming a film from the solution; and forming the magneto-dielectric composite powder from the film.

Aspect 2: The method of aspect 1, wherein the magneto-dielectric composite powder comprises the magnetic filler encapsulated by the polymer.

Aspect 3: The method of aspect 1 or 2, wherein forming the film from the solution comprises: coating the solution on a carrier; and evaporating at least a portion of the solvent to form the film.

Aspect 4: The method of any one of aspects 1 to 3, wherein forming the magneto-dielectric composite powder from the film comprises shredding and milling the film.

Aspect 5: A method of forming a magneto-dielectric composite powder, the method comprising: compounding a polymer and a magnetic filler to form a compounded mixture; extruding the compounded mixture to form an extrudate; and forming the magneto-dielectric composite powder from the extrudate.

Aspect 6: The method of aspect 5, wherein forming the magneto-dielectric composite powder from the extrudate comprises shredding and milling the extrudate.

Aspect 7: The method of any one of aspects 1 to 6, wherein the solution comprises, based on a total weight of the solution: 20 to 80 weight percent of the polymer; 20 to 80 weight percent of the magnetic filler; and 20 to 80 weight percent of the solvent.

Aspect 8: The method of any one of aspects 1 to 7, wherein the film comprises, based on a total weight of the film: 20 to 80 weight percent of the polymer; and 20 to 80 weight percent of the magnetic filler.

Aspect 9: The method of any one of aspects 1 to 8, wherein the magneto-dielectric composite powder comprises, based on a total weight of the magneto-dielectric composite powder: 20 to 80 weight percent of the polymer; and 20 to 80 weight percent of the magnetic filler.

Aspect 10: The method of any one of aspects 1 to 9, wherein the magneto-dielectric composite powder has a size in a range of 1 to 300 micrometers.

Aspect 11: The method of any one of aspects 1 to 10, wherein the magneto-dielectric composite powder has a density of 1 to 5.5 grams per cubic centimeter or 5 to 5.5 grams per cubic centimeter.

Aspect 12: The method of any one of aspects 1 to 11, wherein: the polymer comprises a thermoset; and the solution further comprises an initiator.

Aspect 13: The method of any one of aspects 1 to 12, wherein the polymer comprises a thermoplastic.

Aspect 14: A magneto-dielectric composite powder formed by the method of any one of aspects 1 to 13.

Aspect 15: A method of forming a magneto-dielectric composite article, the method comprising: forming a magneto-dielectric composite powder according to any one of aspects 1 to 14; and molding the magneto-dielectric composite powder to form the magneto-dielectric composite article.

Aspect 16: The method of aspect 15, wherein: the polymer comprises a thermoset; and the molding is performed at a temperature of less than 30 °C.

Aspect 17: The method of aspect 15 or 16, wherein: molding the magneto-dielectric composite powder to form the magneto-dielectric composite article comprising loading the magneto-dielectric composite powder into a mold; and the method further comprises removing the magneto-dielectric composite article from the mold and curing the magneto-dielectric composite article outside of the mold.

Aspect 18: The method of aspect 15, wherein: the polymer comprises a thermoplastic; and molding the magneto-dielectric composite powder to form the magneto-dielectric composite article comprises subjecting the magneto-dielectric composite powder to a temperature of 80 to 250 °C and a pressure of 50 to 1,000 pound per square inch (345 to 6,895 kilopascals).

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. Reference to “an” element in a claim followed by reference to “the” element is inclusive of one element and a plurality of the elements. The term “or” means “and/or” unless clearly indicated otherwise by context. Reference throughout the specification to “an aspect,” “another aspect,” and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film, region, or substrate is referred to as being “on” another element, it can be directly on the other element or intervening elements can also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt%, or 5 to 20 wt%” is inclusive of the endpoints and all intermediate values of the ranges of “5 to 25 wt%,” such as 10 to 23 wt%, etc.). The terms “first,” “second,” and the like, “primary,” “secondary,” and the like, as used herein do not denote any order, quantity, or importance, but rather are used to distinguish one element from another. The term “combination thereof” is open, and means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or can be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method of forming a magneto-dielectric composite powder, the method comprising:
forming a solution comprising a polymer, a magnetic filler, and a solvent;
forming a film from the solution; and
forming the magneto-dielectric composite powder from the film.

2. The method of claim 1, wherein the magneto-dielectric composite powder comprises the magnetic filler encapsulated by the polymer.

3. The method of claim 1, wherein forming the film from the solution comprises:
coating the solution on a carrier; and
evaporating at least a portion of the solvent to form the film.

4. The method of claim 1, wherein forming the magneto-dielectric composite powder from the film comprises shredding and milling the film.

5. A method of forming a magneto-dielectric composite powder, the method comprising:
compounding a polymer and a magnetic filler to form a compounded mixture;
extruding the compounded mixture to form an extrudate; and
forming the magneto-dielectric composite powder from the extrudate.

6. The method of claim 5, wherein forming the magneto-dielectric composite powder from the extrudate comprises shredding and milling the extrudate.

7. The method of claim 1, wherein the solution comprises, based on a total weight of the solution:
20 to 80 weight percent of the polymer;
20 to 80 weight percent of the magnetic filler; and
20 to 80 weight percent of the solvent.

8. The method of claim 1, wherein the film comprises, based on a total weight of the film:
20 to 80 weight percent of the polymer; and
20 to 80 weight percent of the magnetic filler.

9. The method of claim 1, wherein the magneto-dielectric composite powder comprises, based on a total weight of the magneto-dielectric composite powder:
20 to 80 weight percent of the polymer; and
20 to 80 weight percent of the magnetic filler.

10. The method of claim 1, wherein the magneto-dielectric composite powder has a size in a range of 1 to 300 micrometers.

11. The method of claim 1, wherein the magneto-dielectric composite powder has a density of 1 to 5.5 grams per cubic centimeter or 5 to 5.5 grams per cubic centimeter.

12. The method of claim 1, wherein:
the polymer comprises a thermoset; and
the solution further comprises an initiator.

13. The method of claim 1, wherein the polymer comprises a thermoplastic.

14. A magneto-dielectric composite powder formed by the method of claim 1.

15. A method of forming a magneto-dielectric composite article, the method comprising:
forming a magneto-dielectric composite powder according to claim 1; and
molding the magneto-dielectric composite powder to form the magneto-dielectric composite article.

16. The method of claim 15 wherein:
the polymer comprises a thermoset; and
the molding is performed at a temperature of less than 30 °C.

17. The method of claim 15 wherein:
molding the magneto-dielectric composite powder to form the magneto-dielectric composite article comprising loading the magneto-dielectric composite powder into a mold; and
the method further comprises removing the magneto-dielectric composite article from the mold and curing the magneto-dielectric composite article outside of the mold.

18. The method of claim 15 wherein:
the polymer comprises a thermoplastic; and
molding the magneto-dielectric composite powder to form the magneto-dielectric composite article comprises subjecting the magneto-dielectric composite powder to a temperature of 80 to 250 °C and a pressure of 50 to 1,000 pound per square inch (345 to 6,895 kilopascals).
